(19) United States
(12) Patent Application Publication
(10) Pub. No.: US 2006/0214385 A1
(43) Pub. Date: Sep. 28, 2006

(54) Glide board playground feature

(76) Inventors: Brian Henry, Fort Payne, AL (US); Daniel V. Byrd, Ft. Payne, AL (US); Kim Blackwood, Boaz, AL (US)

Correspondence Address: WELSH & KATZ, LTD, 120 S RIVERSIDE PLAZA, 22ND FLOOR, CHICAGO, IL, 60606, US

(21) Appl. No.: 11/085,974

(22) Filed: Mar. 22, 2005

(51) Int. Cl. B60K 1/00; B62M 1/00

(52) U.S. Cl. 280/87.042; 180/65.8

(57) ABSTRACT

A playground play feature is provides, the feature comprises a track having a glide board thereon, such that a user may run and jump onto the glide board and propel the board along the length of the track. The glide board, in a preferred embodiment, comprises a rubber, or similar material, covered board having wheels, the wheels designed to fit within means, such as angled side rails, so that the glide board is held onto the track along the entire length of the track. The track further comprises shock absorbing end caps so as to more controllably stop the glide board as it nears the end of the track.

### FIELD OF THE INVENTION

The present invention concerns a playground feature comprising a glide board on which a person may ride, in the manner of a skateboard, along a track. More particularly the present invention concerns a device wherein a track is built into the ground in a playground area and a glide board is attached thereto such that a child, or other person, may glide the length of the track upon the board in the manner of a skateboard.

### BACKGROUND OF THE INVENTION

Playgrounds are traditionally equipped with all types of traditional play features, such as slides, swings, teeter-totters upon which children can play. While these features are fun, they have over time become somewhat ordinary. Particularly, with kids being more interested in speed, such as that provided by inline skates and skateboards, slides and swing sets have become boring. It has been found, however, that skates and skateboards, due to the inconsistency in riding surfaces and the ability of the user to choose an unsafe location for play, that many injuries, including serious injuries occur with frequency. Further, skateboard and skate users have been found to be using there equipment in places where pedestrians travel, including malls, walkways, building entrances and others, posing a threat of injury to themselves and bystanders. In addition, there are children who cannot afford to purchase skates or skateboards and are often left out of the fun and excitement provided by these devices, even when skateboard friendly areas are provided in playgrounds.

It would be beneficial to have a device that provides the speed and enjoyment of skates or skateboards while providing a safe environment in which to play. Further, it would be desirable to provide a track on which a glide board could be used giving a straight, smooth run. It would also be desirable to provide skateboard excitement to children who cannot afford to purchase skates or skateboards.

### SUMMARY OF THE INVENTION

In accordance with the present invention, a playground play feature is provided having a glide board on which a person may ride while standing thereon. The glide board is attached to a track on the surface of a playground and moves along the track in the manner of a skateboard. The glide board play feature comprises means to skate along a surface a track, affixed to the ground, having a desirable skating run length, and means to secure for lateral movement the glide board thereto. In order to provide a safe ride, the ends of the track have shock absorbing means built in at each end of the track. In this manner, as a person rides on the glide board, the glide board is brought to a gentle stop at the end of skating run.

Further, the glide board and track of the present invention are configured so that they are easily cleared of debris and blockage typically found in playgrounds. The general design of the track and glide board permits the device to naturally clear itself of most types of debris and other materials, such as leaves and wood chips, so that the glide board moves easily along the track under most conditions.

The playground play feature, in a preferred embodiment has a track that is made of angled steel side rails. In such an embodiment the glide board comprises wheels, to permit movement, the wheels are placed within the angled steel side rails such that the glide board is held to the track by the upper rail portion. The rails and track are generally protected by softer, energy absorbing materials, that provide safety and comfort to users, while providing a finished look to the overall play feature, adding color if desired and assisting in maintaining the feature clear of debris.

In one embodiment of the playground play feature the track includes a sub floor and a rubber sheet along the length of the track to provide a smooth running surface for the track. In other embodiments, the play feature may include a glide board that comprises a rubber clad aluminum board with steel trucks for holding at least four wheels. Such a glide board has been found to provide superior ride performance while giving added strength and durability to the glide board. Such embodiments include ramped ends that are flush, at their distal ends, flush with the ground so that there is little possibility of the user being tripped at the end of the board, either when entering upon the play feature, or when running off after a ride. Penulitmately to the ramped ends, the rail within which the glide board is held onto the board is capped with energy absorbing rail covers and the ends comprise shock absorbing springs upon which the glide board strikes at the end of a run. The shock absorbing means, in a preferred embodiment, cause a more gradual slowing of the glide board on the track, so that the user can end his ride more gently.

A more detailed explanation of the invention is provided in the following description and claims and is illustrated in the accompanying drawings.

### BRIEF DESCRIPTION OF THE DRAWINGS

FIG. 1 is a perspective view of one embodiment of the glide board and track of the play feature of the present invention.

FIG. 2 is a perspective view of the glide board of the present invention partially cut away to show underlying features.

FIG. 3 is a perspective view of the frame and track of the play feature of the present invention in a preliminary stage of construction.

FIG. 3a is another perspective view of the frame and track of FIG. 3 in a more advanced stage of construction.

FIG. 3b is another perspective view of the frame and track of FIG. 3 in a more advanced stage of construction.

FIG. 4. is a perspective view of shock absorbing elements and track of one embodiment of the present invention.

FIG. 5 is a perspective view of a glide board of the present invention in place on a track.

FIG. 6 is a partial perspective view of a complete track and glide board of the present invention.

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of the Illustrative Embodiment”) relates to a requirement of the United States Patent Office, and should not be found to limit the subject matter disclosed herein.

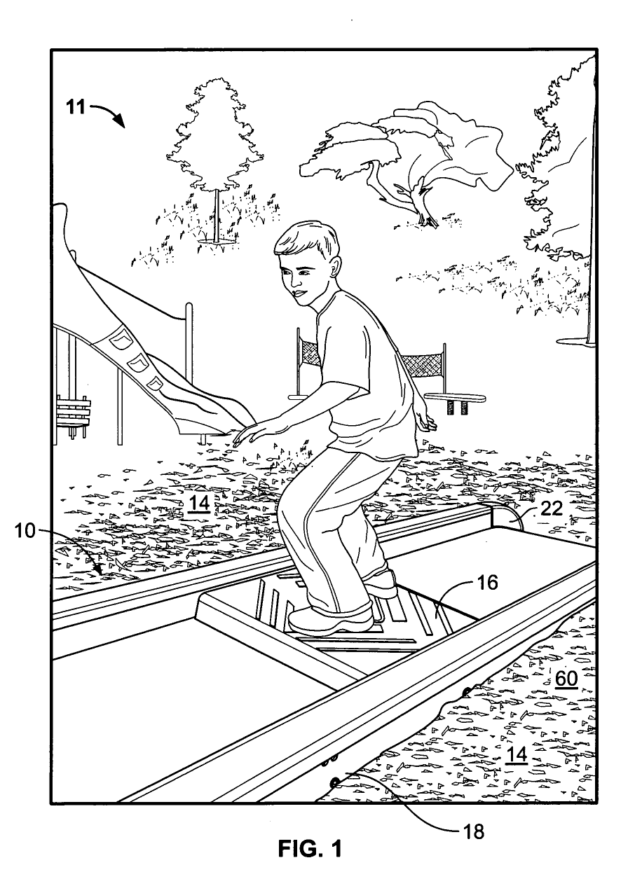

Referring to the drawings, FIG. 1 shows the play feature 10 of the present invention. Play feature 10 is shown in such a manner as to demonstrate its placement in a playground 11, affixed in the ground with a bed of loosely packed materials 14, preferably wood chips as shown or foam, spread around to provide a softer landing for users of the play feature.

In the placement of the play feature 10 in a playground 11 at least two methods are contemplated. In a first method, the feature includes structural legs that are placed within holes dug into the playground. The holes are, as is known by persons having ordinary skill in the art, typical dug to a point below the frost line in the particular area and then, upon placement of the legs, or footings, filled in with concrete so as to appropriately hold the play feature in the ground. Ramps are provided at each end of the track to bring the user back to ground level gently after the run. Typically, an impact attenuating surface (IAS) made of soft and/or shock absorbent materials, such as rubber or wood chip mulch, is placed under and around the play feature to provide a cushioned landing area or fall zone. The IAS is compacted about the ramps, partially burying the ramps below the IAS.

In a second embodiment, a surface mount version is provided. In such a version a hardened surface, such as a concrete slab, is provided beneath the glide board track and thick rubber tiles, preferably about two inches thick, or poured rubber floor is provided. The frame of the glide board track is bolted to the hardened floor. In such an embodiment, ramps are omitted and the ends of the rail are made flush with the rubber floor surface (by for example, shimming the track), allowing for attenuation of falls.

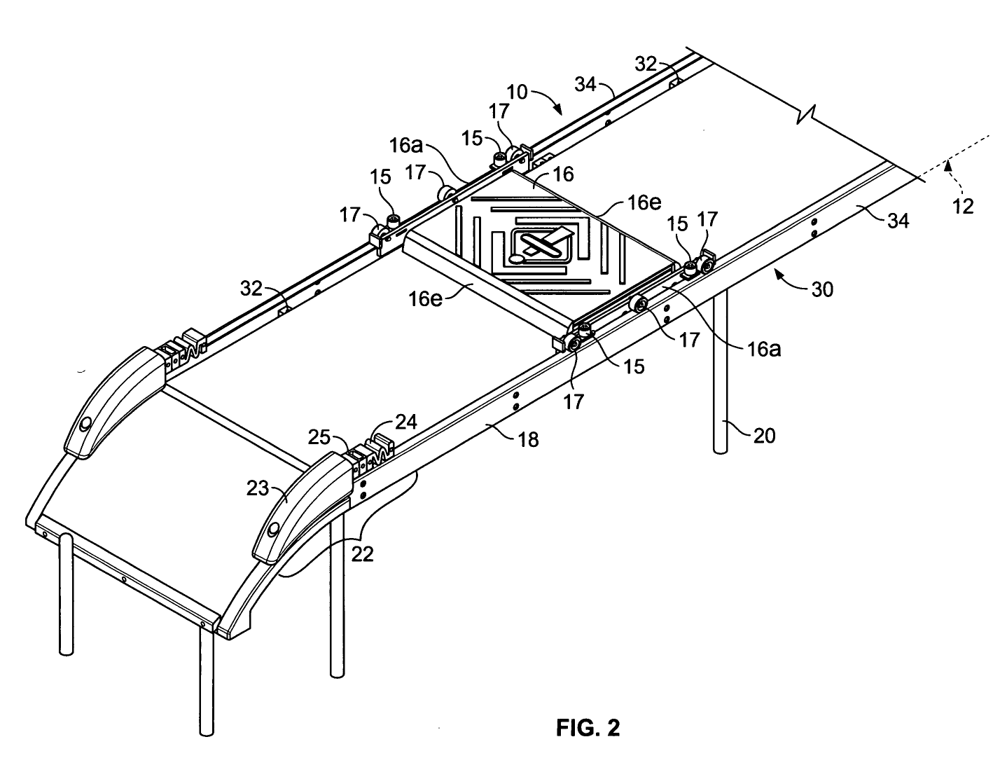

Referring to FIG. 2 a separate view is shown giving both the above ground and below ground features of the present invention; wherein in the surface level of the ground is shown in a phantom line designated as 12. A glide board 16 is shown in association with a track system 18; as well as foot supports 20 and end system 22, comprising shock absorbing means 24 and grounding means 23, as will be described in greater detail below.

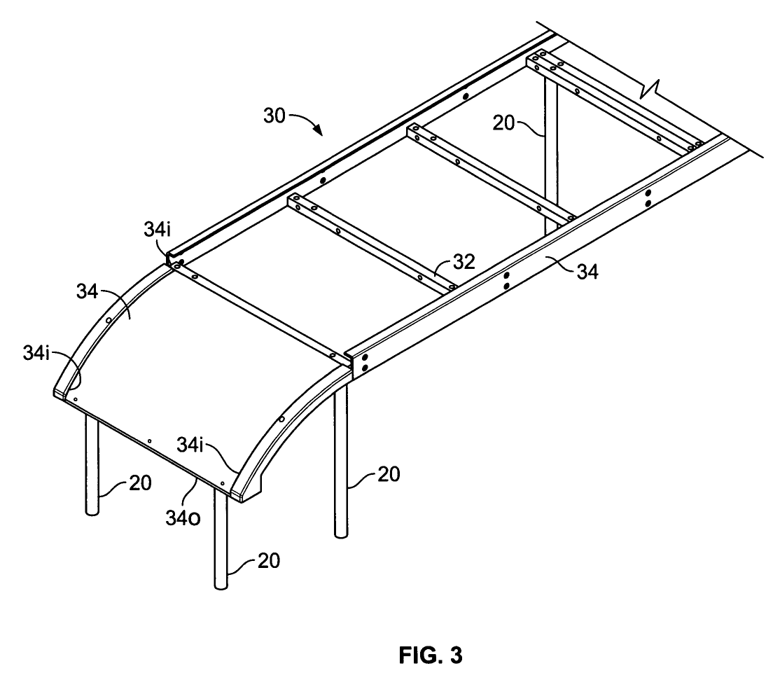

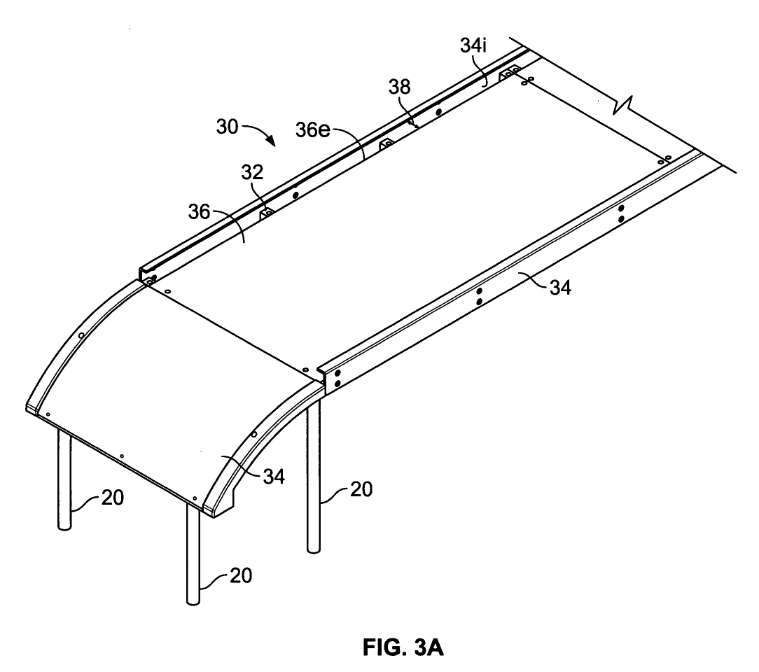

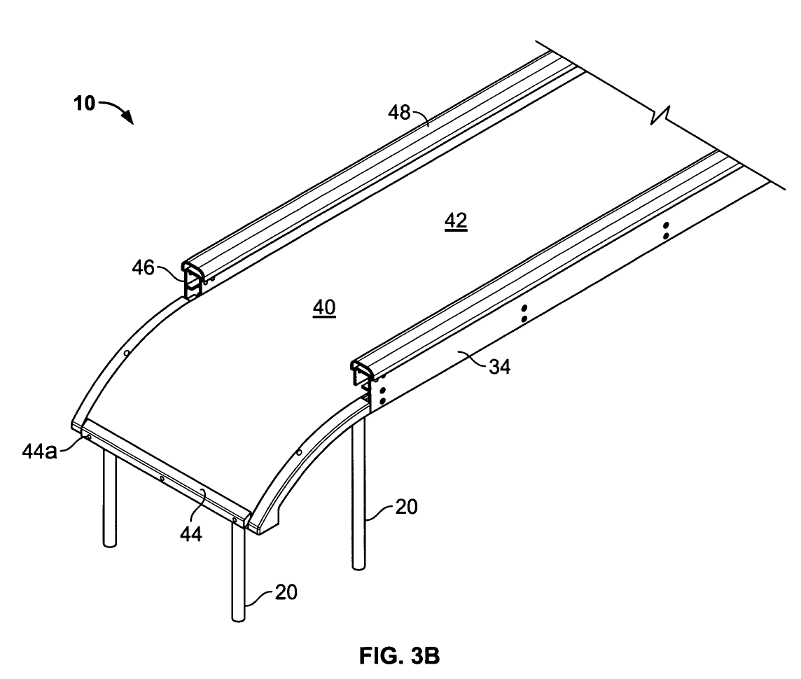

Track system 18 comprises a complex system designed to provide stability in use, shock absorption and comfort, as well as strength and durability, especially when used in an out door environment. Specifically, and referring to FIG. 2, in one embodiment, track system 18 comprises a frame 30 consisting of tubular steel cross bars 32 (more clearly shown in FIG. 3), which are attached, preferably by welding, to angle steel side rails 34. Angle steel side rails 34 provide means of holding the wheels 17 of glide board 16 onto track system 18, as will be explained in more detail below. Frame 30, in the present embodiment, is bolted to foot supports 20, which are buried in holes filled with concrete to keep track system 16 in place in a playground. Foot support holes are preferably 18 inches deep or deeper. It will be understood that placement in holes that reach below the frost line is preferred such that the track system in maintained in place regardless of the season, and seasonal ground movements, causes in part by frost and thaw cycles. The frame 30 is attached to foot supports 20 in such a manner as to elevate rails 34 so that ground debris is prevented from interfering with the movements of glide board 16 within rails 34.

Referring to FIG. 3, a curved ramp 36, preferably made of roto-molded plastic having appropriate structural strength is provided attached to each side of the play feature 10. Each ramp 34 is bolted to the frame assembly 30 on one end and is attached to foot supports 20 on the other end. The ramps 34, in a preferred embodiment, are each approximately 12 inches in height; touching the ground on the outboard end 34o and ending up flush with the frame assembly 30 on the inboard end 34i. In the construction and use of the play feature 10 of the present invention, ramps 34 are design to be partially buried in an impact attenuating surfacing (IAS) or the loosely packed material 14. It will be understood that as children play on the IAS 14, it is caused to compact. The curved ramps 34 are designed, therefore, to make a smooth transition from the glide board 16 to the IAS 14 when the IAS 14 is compacted. The curves, therefore provide an easy transition that would not be possible with blunt ends. It will be understood, as previously explained, that where a hardened surface set up is created, ramps 34 are unnecessary as the ends of the track are abutted with a rubberized surface to create an impact attenuating zone.

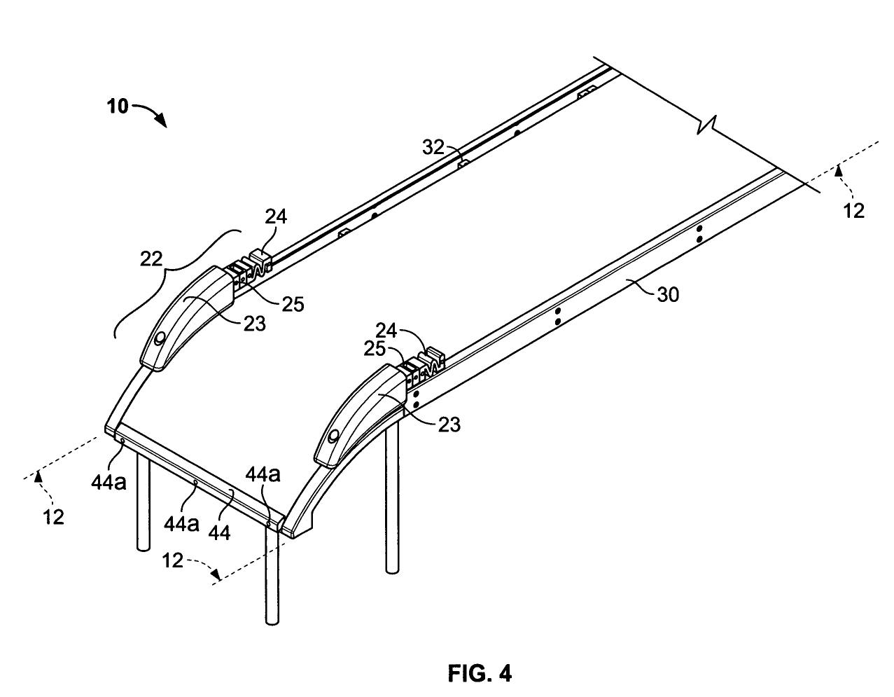

Following the installation of ramps 34 a steel sheet sub floor 36 is affixed, preferably using bolts, to the frame 30. The sub floor 36, in the preferred embodiment, is made so that it is 2″ less in width than the frame 30 so as to form a gap 38 between the interior of the side rails 34i and the sub floor edge 36e. The creation of such gap 38 allows any debris, water and IAS to channel off of the floor surface 40 (FIG. 4), keeping the track system 30 clean so that play can progress. It will be understood by persons having ordinary skill in the art that any thickness of steel or other materials (including wood, fiber boards, fiberglass and others), which provides the necessary under flooring and structural properties desired can be used without departing from the novel scope of the present invention. In a preferred embodiment a ⅛ inch painted steel sub board is provided. This type of material has been found to be of appropriate strength and durability for the play feature of the present invention.

Referring to FIG. 3a, a sheet of rubber 42 is layered onto the sub floor 36. Sheet 42, in a preferred embodiment, is made having a width approximately the same as that of the sub floor 36 and is laminated onto the sub floor 36 using, in a preferred embodiment glue. Further, in a preferred embodiment, a continuous ½ inch thick sheet is provided. The sheet 42 is attached to the sub floor 36 in such a manner so that the sheet 42 also extends over and covers the surfaces of ramps 34. Ramps 34 are constructed, in a preferred embodiment, so as to have an indentation 34i (FIG. 3a) molded in the ramps 34 and sheet 42 is fit within the indentation 341, providing a flush surface when sheet 42 is installed. A formed metal clamp 44 (as shown in FIG. 3b) captures the rubber floor 42 and holds it in place, preferably using a number of bolts 44a, however, any means to fasten metal clamp 44 in place is contemplated as within the scope of the present invention. This use of rubber sheet 42 over the sub floor 36 gives a smooth, continuous and flush rubber surface as the finished floor. A shroud 46, preferably formed of metal, caps the angled steel rail 34, and is covered with an impact attenuating rubber 48 (FIG. 3b). Shroud 46, in a preferred embodiment, is bolted to the angled steel side rails 34, covering the track 18.

Referring to FIG. 4, track system 18 is shown partially cut away to show the shock absorbing system 22 of the present invention. A spring 24, preferably formed of butyl rubber, having a backer plate 25, preferably made of tubular steel, and an impact attenuating cap 23, preferably made of cast rubber, are installed on frame 30 so as to provide shock absorption and a steady decrease in forward momentum to the rider. The rubber spring 24 is preferably in the shape of a neoprene rubber spring designed to lessen the impact that occurs when the glide board is slammed into the end. Persons having skill in the art will recognize that springs having different shapes and being made of different materials, but comprising means to provide a similar effect, can be substituted without departing from the novel scope of the present invention. As previously noted the frame system is created angled steel members 34 which form a “U” shaped (“U” laid on its side) cross-section within which the wheels 15, 17 of glide board 16 ride, such that the glide board is captured on the track so that it cannot be removed. The shock absorbing system being placed such that the wheels of the glide board cannot avoid making contact therewith at the end of the ride.

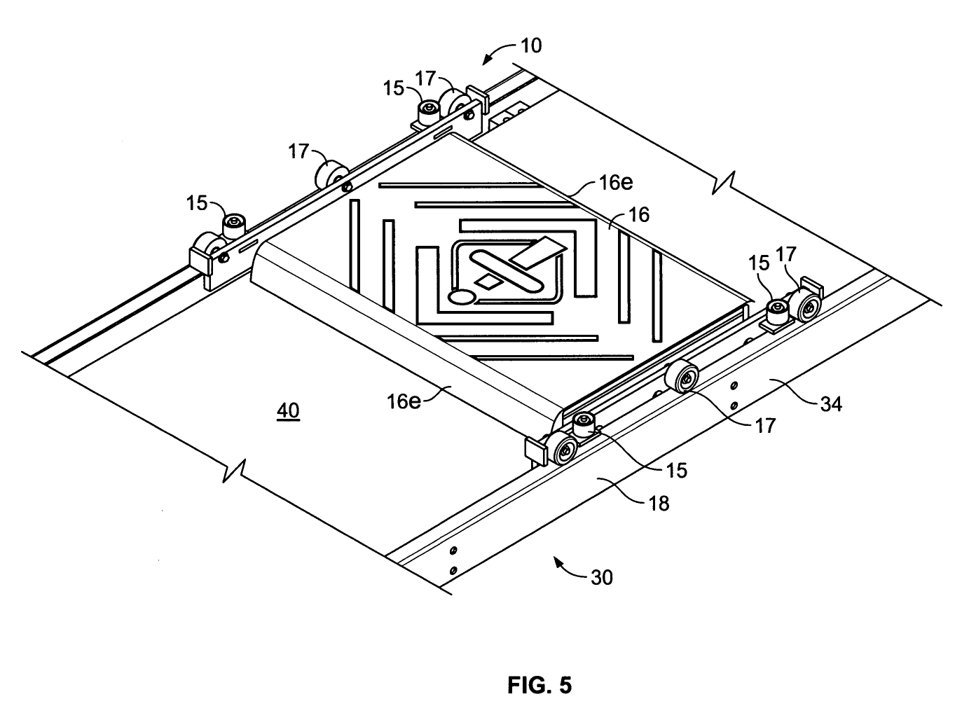

Referring to FIG. 5, the glide board 16, in a preferred embodiment, is a rubber clad, aluminum board with steel trucks 16a that the wheels 17 and the side to side wheels 15 mount. Wheels 17 and side wheels 15 are preferably roller skate type wheels being made of cast urethane. It will be understood by persons having ordinary skill in the art that any type of wheel system, which provides an easy flow of the wheels within or on the track or any type of system that permits the glide board to travel over the track (including methods of hovering, either with air pressure or magnetically/electrically using super conductivity) is contemplated as being within the novel scope of the present invention.

A close up view of the Glide Board assembly 16 is shown in FIG. 5. In a preferred embodiment, glide board 16 is an extruded aluminum board with rubber fused thereupon to provide a structurally significant riding surface. The glide board 16 comprises edge surfaces 16e, which in a preferred embodiment include hollowed out spots (not shown) so as to soften the impact that can be caused by the board on a person, animal or other object, mistakenly on the track during a ride. The placement of the glide board 16 within rails 34 and floor 40 is preferably made so that the glide board “floats’ at about ½ inch above the surface of floor 40. In this preferred height placement debris that falls onto surface 40 can typically be brushed off of the surface by the action of the glide board without causing the glide board to be stopped by debris.

The steel trucks 16a are preferably made of ½ inch painted steel. Ideally, the steel is painted using a powder coated process with a polyester based powder coating. It will be understood by persons having ordinary skill in the art that different materials and coatings can be used, to provide the structural components and aesthetic features of the glide board without departing from the novel scope of the present invention.

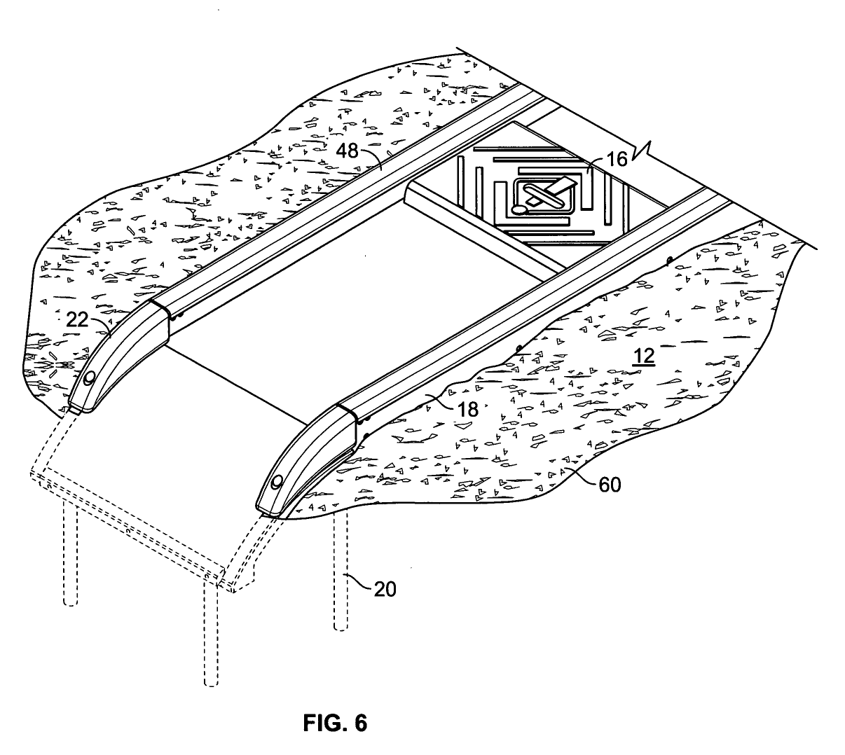

As can be seen FIG. 6, a finished view of the Glide Board Track Ride is shown. In the embodiment shown, the glide board, is an in-ground version, that is it is installed in the ground of a play environment and, as required by numerous jurisdictions and is preferred, 12″ deep wood (or rubber) mulch as a safety surface (known as an in-ground installation) is provided. In the preferred embodiment of the present invention, 18′ deep holes are made in which to place the supports. It will be understood that the holes are made 18″ deep (from ground level) with the mulch (impact attenuating surface) at 12″ deep (from ground level to finish level) installed thereafter. As previously noted, the depth of the holes and attenuating surface may be different in various localities and local codes should be check for appropriate depths; all such depths and installations methods are contemplated as being within the novel scope of the present invention.

As noted above, in another preferred embodiment, the Glide board can be surface mounted. In a surface mount, there is typically a concrete slab with only 2″ thick rubber tiles, bonded rubber floor our poured rubber floor. In the surface mount version, the plastic ramps 23 and the footbucks or legs 20 are omitted as the frame is bolted, or otherwise fastened, directly to the concrete, shimmed at the proper height so the rubber floor is flush with the IAS tiles or poured rubber.

In the use of the play feature of the present invention, a child, or other user, can run up to the glide board 16 and jump thereon, using the momentum of the run and weight of the user to cause the glide board to travel rapidly along track system 18 towards the far end of the track. Upon reaching the far end of the track, the glide board 16 will collide with shock absorbing means 22 causing the glide board to rapidly, but controllably, decelerate to a stop. The user may conduct any number of exciting and fun stunts or activities on the glide board along the path of its travel.

Although an illustrative embodiment of the invention has been shown and described, it is to be understood that various modifications and substitutions may be made by those skilled in the art without departing from the novel spirit and scope of the invention.

What is claimed is:

1. A playground play feature comprising:
a glide board having means to skate along a surface;
a track having a desirable skating run length, and means to secure for lateral movement the glide board thereto;
track ends curved such that the end of the track is at ground level while the body of the track is slightly elevated above the ground.

2. The playground play feature of claim 1, wherein the track comprises angled steel side rails and the glide board comprises wheels, the wheels riding within the angled steel side rails such that the glide board is held to the track.

3. The playground play feature of claim 2, wherein the track includes a sub floor and a rubber sheet along the length of the track to provide a smooth running surface for the track.

4. The playground play feature of claim 1, wherein the glide board comprises a rubber clad aluminum board with steel trucks for holding at least four wheels.

5. The playground play feature of claim 1, wherein the track includes shock absorbing means at either end to more gently stop the glide board at the end of its run.

6. The playground play feature of claim 1, wherein the track is affixed to a surface.

7. The playground play feature of claim 6, wherein the surface is the ground.

8. The playground play feature of claim 1, wherein the track comprises footings and the footings are placed into the surface to secure the track to a surface.

9. The playground play feature of claim 8, wherein the footings are elongated and are buried in openings made in the surface.

10. The playground play feature of claim 8, wherein the footings are diminutive and are secured to a surface with fasteners.

11. A playground play feature comprising:
a glide board having means to skate along a surface;
a track, affixed to the ground, having a desirable skating run length, and means to secure for lateral movement the glide board thereto;
track ends, having shock absorbing means, at each end of the track, such that the glide board is brought to a gentle stop at the end of skating run; and,
the track end is curved so that the track end is at ground level.

12. The playground play feature of claim 11, wherein the track comprises angled steel side rails and the glide board comprises wheels, the wheels riding within the angled steel side rails such that the glide board is held to the track.

13. The playground play feature of claim 12, wherein the track includes a sub floor and a rubber sheet along the length of the track to provide a smooth running surface for the track.

14. The playground play feature of claim 11, wherein the glide board comprises a rubber clad aluminum board with steel trucks for holding at least four wheels.

15. The playground play feature of claim 11, wherein the track is affixed to a surface.

16. The playground play feature of claim 15, wherein the surface is the ground.

17. The playground play feature of claim 11, wherein the track comprises footings and the footings are placed into the surface to secure the track to a surface.

18. The playground play feature of claim 17, wherein the footings are elongated and are buried in openings made in the surface.

19. The playground play feature of claim 17, wherein the footings are diminutive and are secured to a surface with fasteners.
